(19) United States
(12) Patent Application Publication
(10) Pub. No.: US 2018/0098039 A1
(43) Pub. Date: Apr. 5, 2018

(54) PROJECTION APPARATUS AND CONTROL METHOD THEREOF

(71) Applicant: CANON KABUSHIKI KAISHA, Tokyo (JP)

(72) Inventor: Masaya Yagi, Yokohama-shi (JP)

(21) Appl. No.: 15/717,809

(22) Filed: Sep. 27, 2017

(30) Foreign Application Priority Data
Oct. 4, 2016 (JP) 2016-196729

(51) Int. Cl. H04N 9/31

(52) U.S. Cl. CPC H04N 9/3158; H04N 9/312

(57) ABSTRACT

A projection apparatus comprises a projection control unit which controls a projection unit to project at least one of visible light and invisible light, and a control unit which controls a projection state of the projection unit. If the state at the time of shutdown of the apparatus is a state in which the visible light is projected, the control unit controls to set the state in which the visible light is projected at a start of next activation, and if the state at the time of shutdown of the apparatus is a state in which only the invisible light is projected, the control unit controls to set a projection state including at least the visible light at the start of next activation.

### BACKGROUND OF THE INVENTION

### Field of the Invention

The present invention relates to a projection apparatus and a control method thereof.

### Description of the Related Art

There is conventionally provided a projection apparatus (projector) capable of switching between a display mode of projecting a visible image and a display mode of projecting an invisible image such as an infrared image. In the mode of projecting an invisible image, the user can visually perceive an infrared image projected on a screen using a night vision device such as NVG (Night Vision Goggle) (see Japanese Patent Laid-Open No. 2013-524662 and Japanese Patent Laid-Open No. 10-78550).

However, if a projector capable of projecting visible and invisible images is shut down in the display mode of projecting an invisible image, it may be activated, at the time of the next power-on, in the display mode which has been set immediately before shutdown. If projection of an invisible image starts after activation in this way, the user cannot visually perceive the invisible image without using a night vision device such as NVG, and cannot perform a setting operation at the time of activation or confirm the operation state and the like of the apparatus.

### SUMMARY OF THE INVENTION

The present invention has been made in consideration of the aforementioned problems, and provides a technique in which even if an apparatus is set, at the time of shutdown, in a state in which an invisible image is projected, it is possible to visually perceive the projected image after the next activation.

In order to solve the aforementioned problems, the present invention provides a projection apparatus comprising: a projection control unit configured to control a projection unit capable of projecting an image on a projection surface with at least one of visible light and invisible light; and a control unit configured to control a projection state at a start of activation based on a projection state at the time of shutdown of the apparatus, wherein if the state at the time of shutdown of the apparatus is a state in which the visible light is projected, the control unit controls to set the state in which the visible light is projected at a start of next activation, and if the state at the time of shutdown of the apparatus is a state in which only the invisible light is projected, the control unit controls to set a projection state including at least the visible light at the start of next activation.

In order to solve the aforementioned problems, the present invention provides a control method of a projection apparatus having a projection control unit configured to control a projection unit capable of projecting an image on a projection surface with at least one of visible light and invisible light, and a control unit configured to control a projection state at a start of activation based on a projection state at the time of shutdown of the apparatus, the method comprising: controlling, if the state at the time of shutdown of the apparatus is a state in which the visible light is projected, to set the state in which the visible light is projected at a start of next activation, and controlling, if the state at the time of shutdown of the apparatus is a state in which only the invisible light is projected, to set a projection state including at least the visible light at the start of next activation.

In order to solve the aforementioned problems, the present invention provides a computer-readable storage medium storing a program for causing a computer to execute a control method of a projection apparatus having a projection control unit configured to control a projection unit capable of projecting an image on a projection surface with at least one of visible light and invisible light, and a control unit configured to control a projection state at a start of activation based on a projection state at the time of shutdown of the apparatus, the method comprising: controlling, if the state at the time of shutdown of the apparatus is a state in which the visible light is projected, to set the state in which the visible light is projected at a start of next activation, and controlling, if the state at the time of shutdown of the apparatus is a state in which only the invisible light is projected, to set a projection state including at least the visible light at the start of next activation.

According to the present invention, even if an apparatus is set, at the time of shutdown, in a state in which an invisible image is projected, it is possible to visually perceive the projected image after the next activation.

Further features of the present invention will become apparent from the following description of exemplary embodiments (with reference to the attached drawings).

### BRIEF DESCRIPTION OF THE DRAWINGS

FIG. 1 is a block diagram showing an apparatus configuration according to the first embodiment of the present invention;

FIG. 2 is a flowchart illustrating the basic operation of a projection apparatus according to the embodiment;

FIG. 3 is a block diagram showing the configuration of a mode management unit according to the embodiment;

FIG. 4 is a block diagram showing an image processing unit according to the embodiment;

FIG. 5 is a block diagram showing the apparatus configuration of a DLP projector according to the embodiment;

FIG. 6 is a flowchart illustrating the operation of a liquid crystal projector according to the first embodiment;

FIG. 7 is a view showing an example of a night vision goggle;

FIG. 8 is a block diagram showing the configuration of a liquid crystal projector according to the second embodiment;

FIG. 9 is a block diagram showing the configuration of a mode management unit according to the second embodiment;

FIG. 10 is a flowchart illustrating the operation of the liquid crystal projector according to the second embodiment;

FIG. 11 is a block diagram showing the configuration of a liquid crystal projector according to the third embodiment; and

FIG. 12 is a flowchart illustrating the operation of the liquid crystal projector according to the third embodiment.

### DESCRIPTION OF THE EMBODIMENTS

Embodiments of the present invention will be described in detail below. The following embodiments are merely examples for practicing the present invention. The embodiments should be properly modified or changed depending on various conditions and the structure of an apparatus to which the present invention is applied. The present invention should not be limited to the following embodiments. Also, parts of the embodiments to be described later may be properly combined.

### First Embodiment

An embodiment in which a projection apparatus according to the present invention is applied to, for example, a liquid crystal projector for projecting a still image or a moving image will be described below.

<Apparatus Configuration>

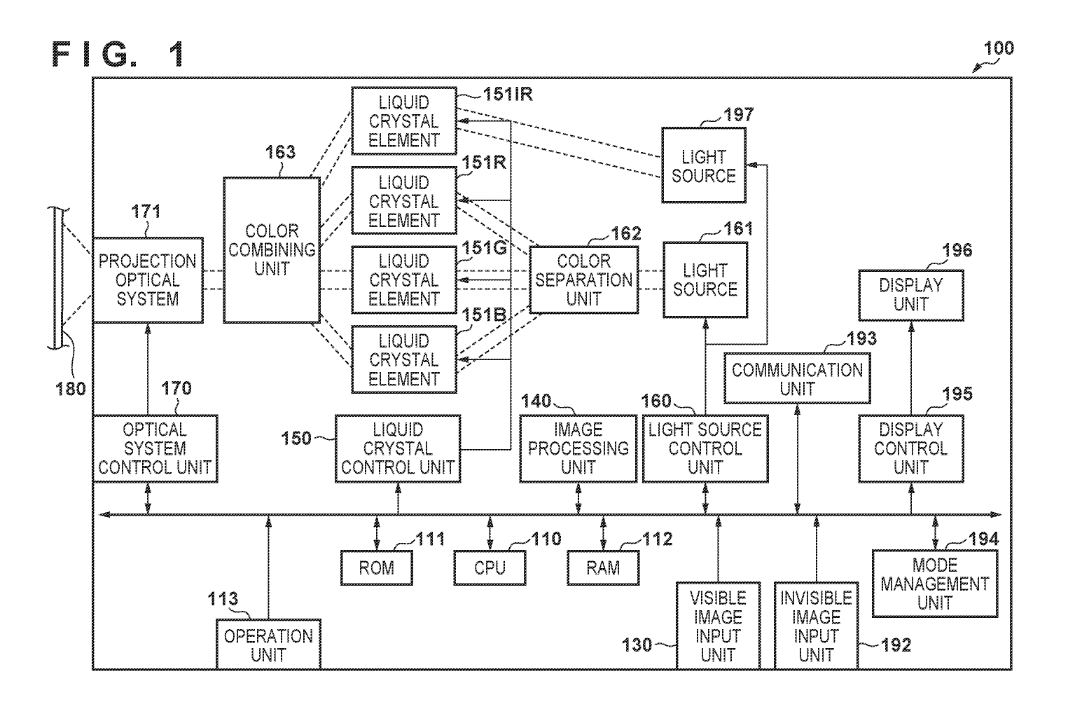

An outline of the configuration and function of the projection apparatus according to the embodiment of the present invention will be described with reference to FIG. 1.

A liquid crystal projector according to this embodiment controls the light transmittances of liquid crystal elements in accordance with an image to be displayed on a projection surface, and projects, on a screen, light from a light source that has passed through the liquid crystal elements, thereby presenting the image to the user.

Referring to FIG. 1, a liquid crystal projector 100 according to this embodiment includes a CPU 110, a ROM 111, a RAM 112, an operation unit 113, a visible image input unit 130, an invisible image input unit 192, and an image processing unit 140. The liquid crystal projector 100 also includes a liquid crystal control unit 150, liquid crystal elements 151R, 151G, 151B, and 151IR, a light source control unit 160, a visible light source 161, an invisible light source 197, a color separation unit 162, a color combining unit 163, an optical system control unit 170, and a projection optical system 171. In addition, the liquid crystal projector 100 includes a communication unit 193, a mode management unit 194, a display control unit 195, and a display unit 196.

The CPU 110 controls each operation block of the liquid crystal projector 100. The ROM 111 stores a control program in which the processing procedure of the CPU 110 is described. The RAM 112 serves as a work memory to temporarily store the control program and data. The CPU 110 can temporarily store, in the RAM 112, video data such as a moving image or a still image received by the communication unit 193, and record it in a recording medium (not shown). The CPU 110 analyzes image data to convert it into in-focus data and luminance distribution data, and causes the optical system control unit 170 and the image processing unit 140 to perform focus adjustment, lens aperture adjustment, reduction processing, color unevenness correction, and the like. Furthermore, the CPU 110 outputs control signals to the image processing unit 140, the liquid crystal control unit 150, the light source control unit 160, and the optical system control unit 170, and the respective operation blocks execute the projection processing of a visible or invisible image in accordance with the control signals from the CPU 110.

The operation unit 113 includes, for example, a switch, a dial, and a touch panel provided on the display unit 196, and accepts a user operation and transmits an operation signal to the CPU 110. The operation unit 113 may include, for example, a signal reception unit (an infrared reception unit or the like) for receiving an operation signal transmitted from a remote controller (not shown), and output the received operation signal to the CPU 110. The CPU 110 receives a control signal input from the operation unit 113 or the communication unit 193, and controls each operation block of the liquid crystal projector 100.

The visible image input unit 130 is an image input unit for displaying visible light constituted by red (R), green (G), and blue (B) light components, and receives a visible light video signal from an external apparatus (not shown). The visible image input unit 130 includes, for example, a composite terminal, an S video terminal, a D terminal, a component terminal, analog R, G, and B terminals, a DVI-I terminal, a DVI-D terminal, an HDMI® terminal, and DisplayPort®. Upon receiving an analog video signal, the visible image input unit 130 converts the received analog video signal into a digital video signal, and transmits it to the image processing unit 140. The external apparatus can be a personal computer, a camera, a portable phone, a smartphone, a hard disk recorder, a game machine, or any other apparatus capable of outputting a video signal.

The invisible image input unit 192 is an image input unit for displaying invisible light represented by infrared light (IR), and receives an invisible light video signal from an external apparatus (not shown). The invisible image input unit 192 includes, for example, a composite terminal, an S video terminal, a D terminal, a component terminal, analog R, G, and B terminals, a DVI-I terminal, a DVI-D terminal, an HDMI® terminal, and DisplayPort®. Upon receiving an analog video signal, the invisible image input unit 192 converts the received analog video signal into a digital video signal, and transmits it to the image processing unit 140. The external apparatus can be a personal computer, a camera, a portable phone, a smartphone, a hard disk recorder, a game machine, or any other apparatus capable of outputting a video signal.

The image processing unit 140 includes, for example, an ASIC formed by a dedicated microprocessor or logic circuit, and performs processing of changing the number of frames, the number of pixels, the image shape, or the like for a video signal received from the visible image input unit 130 or the invisible image input unit 192, and transmits the processed signal to the liquid crystal control unit 150. Note that the image processing unit 140 need not be a dedicated microprocessor. For example, the CPU 110 may execute the same processing as that of the image processing unit 140 using a program stored in the ROM 111. The image processing unit 140 can execute a frame thinning processing function, frame interpolation processing function, resolution conversion processing function, image combining processing function, geometric correction processing (keystone correction processing and curved surface correction processing) function, and panel correction function. The image processing unit 140 can perform the above-described change processing not only for the signal received from the visible image input unit 130 but also for a moving image or still image reproduced by the CPU 110.

The liquid crystal control unit 150 includes an ASIC formed by a dedicated microprocessor or logic circuit. The liquid crystal control unit 150 controls voltages to be applied to the liquid crystals of the pixels of the liquid crystal elements 151R, 151G, 151B, and 151IR of the liquid crystal panels based on the video signal processed by the image processing unit 140, thereby adjusting the transmittances of the liquid crystal elements 151R, 151G, 151B, and 151IR. Note that the liquid crystal control unit 150 need not be a dedicated microprocessor. For example, the CPU 110 may execute the same processing as that of the liquid crystal control unit 150 using a program stored in the ROM 111. For example, when inputting a video signal to the image processing unit 140, every time one frame image data is received from the image processing unit 140, the liquid crystal control unit 150 controls the liquid crystal elements 151R, 151G, 151B, 151IR to have transmittances corresponding to the image. The liquid crystal element 151R is a liquid crystal element corresponding to red, and adjusts the transmittance of red light out of light output from the visible light source 161 and separated (divided) into red (R), green (G), and blue (B) light components by the color separation unit 162. The liquid crystal element 151G is a liquid crystal element corresponding to green, and adjusts the transmittance of green light out of light output from the visible light source 161 and separated (divided) into red (R), green (G), and blue (B) light components by the color separation unit 162. The liquid crystal element 151B is a liquid crystal element corresponding to blue, and adjusts the transmittance of blue light out of light output from the visible light source 161 and separated (divided) into red (R), green (G), and blue (B) light components by the color separation unit 162. The liquid crystal element 151IR is a liquid crystal element corresponding to infrared light (IR), and adjusts the transmittance of infrared light (IR) output from the invisible light source 197.

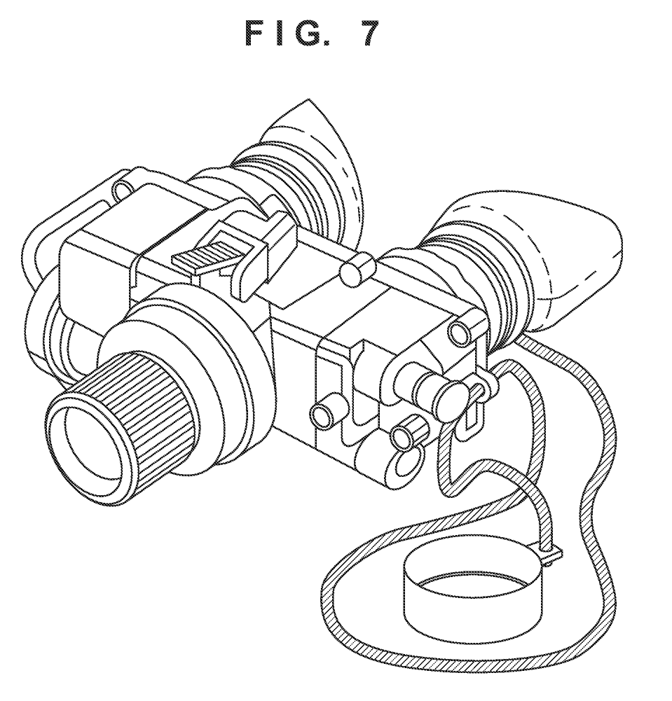

The light source control unit 160 is a sequencer such as an ASIC formed by, for example, a control logic circuit, which controls ON/OFF of the visible light source 161 and invisible light source 197 and their light amounts. Note that the light source control unit 160 need not be a dedicated ASIC. For example, the CPU 110 may execute the same processing as that of the light source control unit 160 using a program stored in the ROM 111. The visible light source 161 and the invisible light source 197 output visible light and invisible light to project images on a screen (not shown), respectively. Each of the visible light source 161 and the invisible light source 197 can be, for example, a halogen lamp, a xenon lamp, a high-pressure mercury lamp, an LED light source, a laser diode, or a light source of a type of converting light wavelength by causing a phosphor or the like to excite light emitted by a laser diode, and outputs light to project an image on a screen 180. The color separation unit 162 includes, for example, a dichroic mirror or a prism, and separates (divides) light output from the visible light source 161 into red (R), green (G), and blue (B) light components. Note that the color separation unit 162 is unnecessary when LEDs corresponding to the respective colors are used as the light source 161. The color combining unit 163 includes, for example, a dichroic mirror or a prism, and combines the red (R), green (G), blue (B), and infrared (IR) light components that have passed through the liquid crystal elements 151R, 151G, 151B, and 151IR. The light obtained by combining the red (R), green (G), blue (B), and infrared (IR) light components by the color combining unit 163 is sent to the projection optical system 171. At this time, the liquid crystal elements 151R, 151G, 151B, and 151IR are controlled by the liquid crystal control unit 150 to have light transmittances corresponding to the image data input from the image processing unit 140. For this reason, when the light combined by the color combining unit 163 is projected on the screen by the projection optical system 171, a visible image and infrared image (invisible image) input from the image processing unit 140 are displayed on the screen. If the invisible image such as an infrared image is projected on the screen, the user can visually perceive the projected image using a night vision device such as NVG (Night Vision Goggle) shown in FIG. 7.

The optical system control unit 170 includes a control microprocessor, and controls the projection optical system 171. Note that the optical system control unit 170 need not be a dedicated microprocessor. For example, the CPU 110 may execute the same processing as that of the optical system control unit 170 using a program stored in the ROM 111. The optical system control unit 170 may be an ASIC formed by a dedicated logic circuit. The projection optical system 171 projects the combined light output from the color combining unit 163 on the screen. The projection optical system 171 includes a plurality of lenses and an actuator for driving the lenses, and can perform enlargement, reduction, shifting, and focus adjustment of the projected image by driving the lenses by the actuator.

The communication unit 193 receives a control signal or image data such as a still image or moving image from an external apparatus, and can be, for example, wireless LAN, wired LAN, USB, or Bluetooth®. The communication system is not particularly limited. If the terminal of the visible image input unit 130 is, for example, an HDMI® terminal, CEC communication may be performed via the terminal. The external apparatus can be a personal computer, a camera, a portable phone, a smartphone, a hard disk recorder, a game machine, a remote controller, or any other apparatus capable of communicating with the liquid crystal projector 100.

The display control unit 195 includes a dedicated microprocessor, and controls to display an operation screen or an image of a switch icon or the like used to operate the liquid crystal projector 100 on the display unit 196 provided in the liquid crystal projector 100. Note that the display control unit 195 need not be a dedicated microprocessor. For example, the CPU 110 may execute the same processing as that of the display control unit 195 using a program stored in the ROM 111. The display unit 196 displays an operation screen or a switch icon used to operate the liquid crystal projector 100. The display unit 196 can be any display capable of displaying an image, and may be, for example, a liquid crystal display, a CRT display, an organic EL display, an LED display, a single LED, or a combination thereof.

Note that the image processing unit 140, the liquid crystal control unit 150, the light source control unit 160, the optical system control unit 170, and the display control unit 195 of this embodiment can be formed from a single or a plurality of microprocessors capable of performing the same processes as those of the units, or an ASIC formed by a logic circuit. Alternatively, for example, the CPU 110 may execute the same processes as those of the blocks using programs stored in the ROM 111.

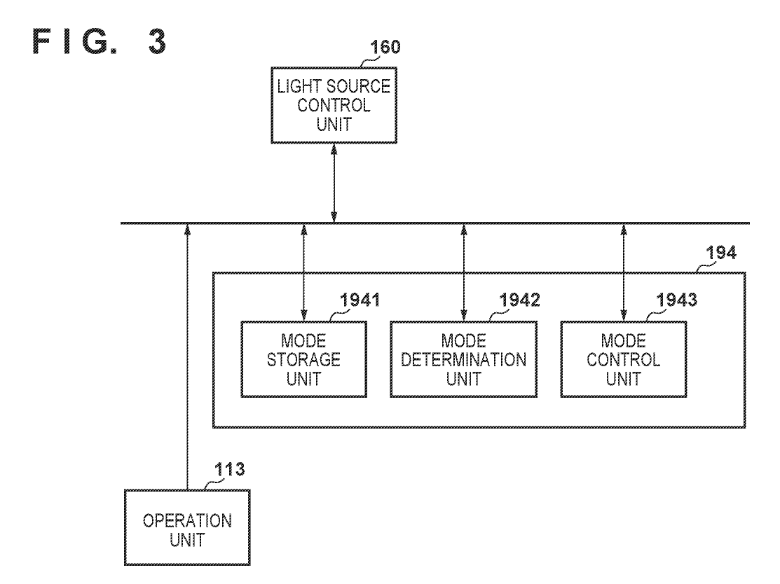

The mode management unit 194 performs shutdown processing after power-off and display mode (projection state) setting processing, and details thereof will be described later with reference to FIG. 3.

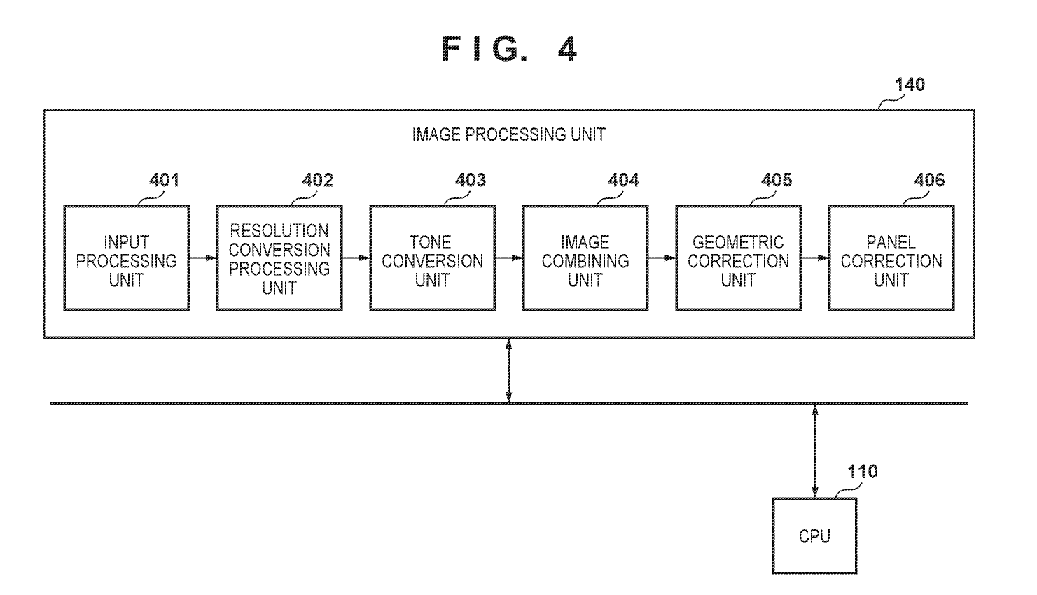

FIG. 4 shows the detailed configuration of the image processing unit 140.

The image processing unit 140 includes an input processing unit 401, a resolution conversion processing unit 402, a tone conversion unit 403, an image combining unit 404, a geometric correction unit 405, and a panel correction unit 406. The image processing unit 140 performs image processing for image data which has been input from an external apparatus to the visible image input unit 130. The input processing unit 401 performs bit depth adjustment, level conversion, color space conversion, frequency conversion, and the like, and sends the thus obtained data to the resolution conversion processing unit 402. The resolution conversion processing unit 402 performs resolution conversion in accordance with the control signal from the CPU 110. The tone conversion unit 403 performs, for the image data having undergone resolution conversion, tone conversion processing such as gamma conversion, color conversion, and sharpness processing in accordance with the control signal from the CPU 110 or by an LUT stored in the RAM 112. The image combining unit 404 adds black image so that the image data having undergone resolution conversion by the resolution conversion processing unit 402 has a panel resolution. The image combining unit 404 combines a menu or symbol created in the RAM 112 or stored in advance in the RAM 112 with the image data having undergone resolution conversion by the resolution conversion processing unit 402, and sends the thus obtained data to the geometric correction unit 405 as an image. The geometric correction unit 405 converts the shape using shape conversion parameters in accordance with the control signal from the CPU 110. The panel correction unit 406 performs gamma correction, in-plane luminance unevenness correction, and the like by an LUT that has been determined in advance by measurement and stored in the RAM 112 in order to absorb the characteristics of the panel. The image data having undergone panel correction is sent to the liquid crystal control unit 150, thereby controlling the liquid crystal elements 151R, 151G, 151B, and 1511R.

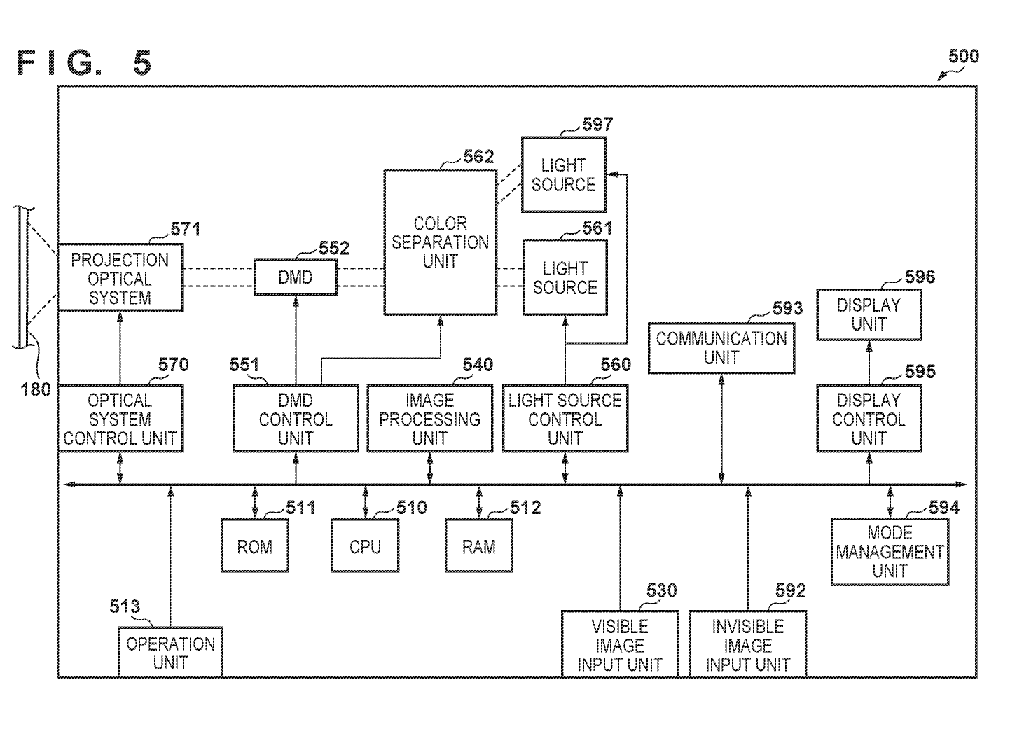

The projection apparatus according to this embodiment may be any apparatus for projecting an image on the screen through a projection optical system such as a lens. For example, a DLP (Digital Light Processing) projector may be used. FIG. 5 exemplifies a configuration when this embodiment is applied to a single-plane CCD DLP projector. The third digits of reference numerals that denote the same components as those of the liquid crystal projector 100 shown in FIG. 1 are set to 5 (a range of 500 to 599), and the difference from the liquid crystal projector 100 will be mainly explained.

Referring to FIG. 5, a DLP projector 500 according to this embodiment includes a CPU 510, a ROM 511, a RAM 512, an operation unit 513, a visible image input unit 530, an invisible image input unit 592, and an image processing unit 540. The DLP projector 500 also includes a DMD (Digital Micromirror Device) 552, a DMD control unit 551, a light source control unit 560, a visible light source 561, an invisible (infrared) light source 597, an optical system control unit 570, a projection optical system 571, and a color separation unit 562. Furthermore, the DLP projector 500 includes a communication unit 593, a mode management unit 594, a display control unit 595, and a display unit 596.

Similarly to the CPU 110 shown in FIG. 1, the CPU 510 controls each operation block of the DLP projector 500, and the ROM 511 stores a control program in which the processing procedure of the CPU 510 is described.

Similarly to the operation unit 113 shown in FIG. 1, the operation unit 513 accepts a user operation and transmits an operation signal to the CPU 510, and includes, for example, a switch, a dial, and a touch panel provided on the display unit 596.

Similarly to the visible image input unit 130 shown in FIG. 1, the visible image input unit 530 is an image input unit for displaying visible light constituted by red (R), green (G), and blue (B) light components, and receives a visible light video signal from an external apparatus (not shown).

Similarly to the invisible image input unit 192 shown in FIG. 1, the invisible image input unit 592 is an image input unit for displaying invisible light represented by infrared light (IR), and receives an invisible light video signal from an external apparatus (not shown).

The image processing unit 540 performs processing of changing the number of frames, the number of pixels, the image shape, or the like for a video signal received from the visible image input unit 530 or the invisible image input unit 592, and transmits the processed signal to the DMD control unit 551.

The color separation unit 562 has a temporal color separation/light transmission function represented by a color wheel capable of separating white light into R, G, and B visible light components and transmitting light from a light source, and can operate in synchronism with a signal sent from the DMD control unit 551. Note that if LEDs corresponding to the respective colors are used as the visible light source 561, RGB separation by the color separation unit 562 is unnecessary.

The DMD control unit 551 is a spatial light modulation element including, for example, an ASIC formed by a logic circuit. The DMD control unit 551 can control the irradiation time of the input light from the light source toward the projection optical system 571 per unit time for each pixel based on the video signal processed by the image processing unit 540, thereby expressing the luminance gradation of the entire screen. Note that the operation of the DMD control unit 551 is described in patent literature 2 described above and a description thereof will be omitted. The DMD control unit 551 is a sequencer such as an ASIC formed by a control logic circuit, which generates a signal synchronized with driving of the DMD 552 with respect to the color separation unit 562 and operates the color separation unit 562 such as a color wheel in synchronism with the DMD 552. Note that the DMD control unit 551 need not be a dedicated ASIC. For example, the CPU 510 may execute the same processing as that of the DMD control unit 551 using a program stored in the ROM 511.

The light source control unit 560 controls ON/OFF of the visible light source 561 and invisible light source 597 and their light amounts.

The optical system control unit 570 controls the projection optical system 571. The projection optical system 571 projects light output from the DMD 552 on the screen.

The communication unit 593 receives a control signal or image data such as a still image or moving image from an external apparatus.

The display control unit 595 controls to display an operation screen or an image of a switch icon or the like used to operate the DLP projector 500 on the display unit 596 provided in the DLP projector 500.

The mode management unit 594 performs shutdown processing after power-off and display mode (projection state) setting processing, and details thereof will be described later with reference to FIG. 3.

Note that the image processing unit 540, the light source control unit 560, the optical system control unit 570, and the display control unit 595 of this embodiment can be formed from a single or a plurality of microprocessors capable of performing the same processes as those of the operation blocks, or an ASIC formed by a logic circuit. Alternatively, for example, the CPU 510 may execute the same processes as those of the blocks using programs stored in the ROM 511.

<Basic Operation>

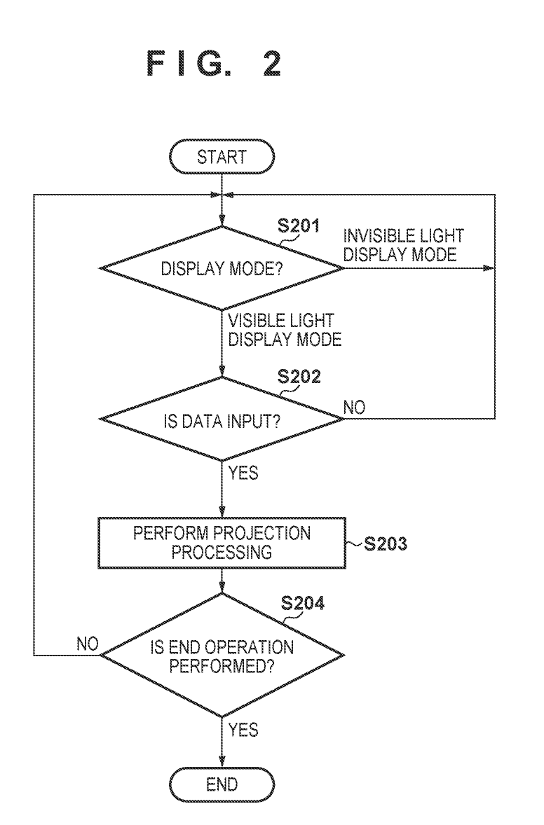

The basic operation of the liquid crystal projector 100 according to this embodiment will be described with reference to FIGS. 1 and 2. Note that the operation of the configuration shown in FIG. 5 is the same as in FIG. 2 except for a spatial modulation element and a method of driving it and a description thereof will be omitted.

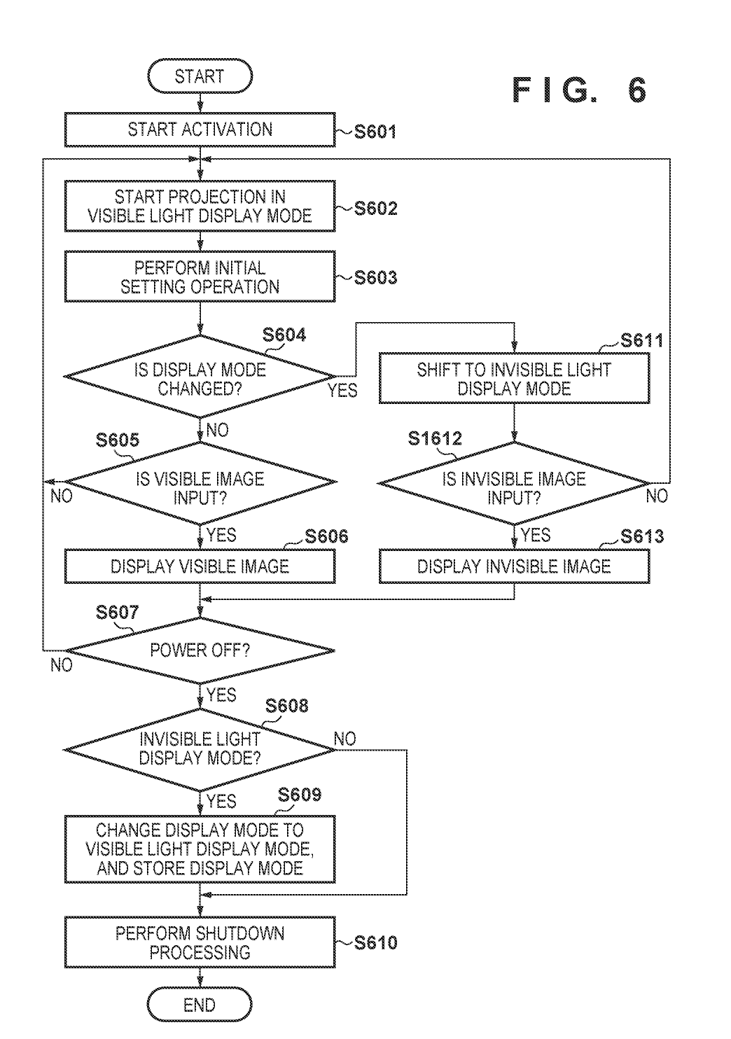

FIG. 2 is a flowchart illustrating the basic operation of the liquid crystal projector 100 according to this embodiment. Note that the operation shown in FIG. 2 is implemented when the CPU 110 loads the programs stored in the ROM 111 into the work area of the RAM 112 and controls the operation blocks. The operation shown in FIG. 2 starts when an operation signal to power on the liquid crystal projector 100 is input by a user operation via the operation unit 113 or a remote controller. If the user powers on the liquid crystal projector 100 using the operation unit 113 or the remote controller, the CPU 110 causes a power supply control unit (not shown) to start power supply from a power supply unit (not shown) to the respective units of the liquid crystal projector 100. The same applies to FIGS. 6, 10, and 12 (to be described later).

The CPU 110 determines the display mode selected by a user operation via the operation unit 113 or the remote controller (step S201). The display mode includes a visible light display mode (first display mode) of displaying a visible image input from the visible image input unit 130 and an invisible light display mode (second display mode) of displaying an invisible image input from the invisible image input unit 192. Note that this embodiment will describe a case in which the user selects the display mode. However, the apparatus may be activated in the display mode set at the time of the previous shutdown, or activated by setting one of the above display modes as a default display mode. In this case, the processing in step S201 can be skipped. If the liquid crystal projector 100 according to this embodiment is a projector capable of projecting visible and invisible images at the same time, the display mode may include a display mode (third display mode) capable of projecting visible and invisible images at the same time and changing the projection ratio or projection proportion between the visible and invisible images, in addition to the above-described first and second display modes.

The description assumes that the “visible light display mode” is selected in step S201. The same applies to a case in which the “invisible light display mode” is selected.

If the “visible light display mode” is selected, the CPU 110 stands by until video data is input from the visible image input unit 130 (step S202). If video data is input (YES in step S202), the process shifts to projection processing (step S203). The mode management unit 194 determines and stores the mode selected in step S201, and manages the display mode in coordination with light source control.

In step S203, the CPU 110 causes the image processing unit 140 to change the number of pixels, the frame rate, the image shape, or the like of the video data input from the visible image input unit 130, and transmits processed image data of one screen to the liquid crystal control unit 150. The CPU 110 causes the liquid crystal control unit 150 to control the transmittances of the liquid crystal elements 151R, 151G, and 151B of the liquid crystal panels to transmittances corresponding to the tone levels of the red (R), green (G), and blue (B) light components of the received image data of one screen. The CPU 110 causes the light source control unit 160 to control the output of light from the visible light source 161. The color separation unit 162 separates the light output from the visible light source 161 into red (R), green (G), and blue (B) light components, and supplies the light components to the liquid crystal elements 151R, 151G, and 151B of the liquid crystal panels. For the light components of the respective colors supplied to the liquid crystal elements 151R, 151G, and 151B, the amount of light to pass through is limited for each pixel of the liquid crystal elements. The red (R), green (G), and blue (B) light components that have passed through the liquid crystal elements 151R, 151G, and 151B, respectively, are supplied to the color combining unit 163 and combined again. The light combined by the color combining unit 163 is projected on the screen 180 via the projection optical system 171.

This projection processing is sequentially executed for each frame image data during the projection of the image.

Note that if an operation signal of the projection optical system 171 is input by a user operation via the operation unit 113 or the remote controller, the CPU 110 causes the optical system control unit 170 to control the actuator of the projection optical system 171 to change the focus of the projected image or change the enlargement ratio of the optical system.

During execution of the projection processing, the CPU 110 determines whether an operation signal to switch the display mode is input by a user operation via the operation unit 113 or the remote controller (step S204). If an operation signal to switch the display mode is input (YES in step S204), the CPU 110 returns to step S201, and determines the display mode. At this time, the CPU 110 transmits a menu screen to select the display mode to the image processing unit 140 as OSD (On Screen Display) image data, and controls the image processing unit 140 to superimpose the menu screen (OSD) on the projected image. The user can select the display mode while viewing the menu screen (OSD). After the display mode is selected, the user can perform various setting operations concerning the projector while viewing the menu screen (OSD).

On the other hand, if no operation signal to switch the display mode is input by a user operation via the operation unit 113 or the remote controller during execution of the projection processing (NO in step S204), the process returns to step S201, and repeats the processes in steps S201 to S204 until an operation signal to end projection is input. If an operation signal to end projection is input (YES in step S204), the CPU 110 stops power supply to the respective operation blocks of the liquid crystal projector 100 and ends the projection processing.

As described above, the liquid crystal projector 100 according to this embodiment projects an image on the screen.

<Mode Management Unit>

The configuration and function of the mode management unit 194 will be described with reference to FIG. 3.

The mode management unit 194 includes a mode storage unit 1941, a mode determination unit 1942, and a mode control unit 1943. The CPU 110 notifies the mode management unit 194 of the display mode selected by the user in step S201 of FIG. 2 or the display mode determined at the time of activation. The mode management unit 194 causes the mode storage unit 1941, the mode determination unit 1942, and the mode control unit 1943 to perform activation processing at the time of power-on, shutdown processing after power-off, and display mode setting processing in accordance with the display mode.

The mode storage unit 1941 stores the display mode set at the time of the previous shutdown. The mode storage unit 1941 is a nonvolatile internal memory or an external storage medium such as an HDD or memory card but may be implemented by a volatile memory as long as it is possible to hold stored contents by keeping the memory unit ON even after the projector main body is powered off.

The mode determination unit 1942 determines the display mode at the time of activation or shutdown of the projector main body. If the mode determination unit 1942 determines that the display mode is the invisible light display mode, the mode control unit 1943 changes the display mode from the invisible light display mode to the visible light display mode. Furthermore, the mode storage unit 1941 stores the visible light display mode whose setting has been changed by the mode control unit 1943. After that, the shutdown processing of the projector main body is executed.

<Operation After Power-On>

The operation of the liquid crystal projector 100 according to this embodiment after power-on will be described with reference to FIG. 6.

It is assumed that the liquid crystal projector 100 according to this embodiment is activated in the display mode set at the time of the previous shutdown and stored in the mode storage unit 1941 of the mode management unit 194.

FIG. 6 illustrates the operation of the liquid crystal projector 100 according to this embodiment after power-on.

In step S601, if a power-on operation signal is input by a user operation via the operation unit 113 or the remote controller, the CPU 110 starts power supply to the liquid crystal projector 100 and performs activation processing of the respective operation blocks.

In step S602, the CPU 110 outputs, to the light source control unit 160, a control signal to turn on the visible light source 161, and starts projection in the visible light display mode. In the visible light display mode, a menu screen or an image corresponding to guidance display is displayed with visible light. Note that in this case, whether to activate the liquid crystal projector 100 in the visible light display mode may be switched in accordance with the brightness of a place where the liquid crystal projector 100 is installed. For example, if the installation place is an environment whose luminance is lower than predetermined one, the user may visually perceive an invisible image using a night vision device such as NVG, and thus the projector may be activated in the display mode set at the time of the previous shutdown without switching the display mode to the visible light display mode.

In step S603, if the user performs a setting operation via the menu screen (OSD) in the visible light display mode after activation, the CPU 110 performs an initial setting operation in accordance with the user operation. For example, the initial setting operation targets items that can be operated when using the projector, including the display mode setting of the image processing unit 140 and the setting of the optical system control unit 170, and corresponds to a series of setting operations concerning projection. For example, the initial setting operation includes communication setting of LAN, RS232, or the like, color adjustment, luminance adjustment, display mode setting, confirmation of the state of the main body, remote controller reception channel setting, projection mode setting, display shape setting, display aspect setting, setting parameter change or confirmation, setting concerning a peripheral member, operation log confirmation, menu position change, menu language change, display position adjustment, and test image display setting. In addition to them, items set by visually displaying the menu screen (OSD) are targeted.

In step S604, the CPU 110 determines whether an operation signal to change the display mode is input by a user operation via the operation unit 113 or the remote controller. If no operation signal to change the display mode is input, the process advances to step S605. If an operation signal to change the display mode from the visible light display mode to the invisible light display mode is input, the process advances to step S612.

In step S605, the CPU 110 determines whether a visible light video signal is input from the visible image input unit 130 in the visible light display mode. If a visible image is input, the process advances to step S606; otherwise, the process returns to step S602 to repeat the processes in steps S602 to S605.

In step S606, the CPU 110 performs projection control to display the visible light video signal input in step S605, thereby performing projection display of the visible image.

In step S607, the CPU 110 determines whether a power-off operation signal is input by a user operation via the operation unit 113 or the remote controller while the visible image is displayed in step S606. If a power-off operation signal is input, the process advances to step S608; otherwise, the process returns to step S602 to repeat the processes in steps S602 to S607.

In step S608, before turning off the power to shut down the projector main body, the CPU 110 causes the mode determination unit 1942 of the mode management unit 194 to determine the current display mode. If the display mode is the visible light display mode, the process advances to step S611. If the display mode is the invisible light display mode, the process advances to step S609.

In step S609, the CPU 110 outputs a control signal to the mode management unit 194 to change the current display mode to the visible light display mode. The mode management unit 194 causes the mode control unit 1943 to change the display mode to the visible light display mode, and causes the mode storage unit 1941 to store the visible light display mode as the display mode.

In step S610, the CPU 110 performs shutdown processing. Note that if a power-off operation signal is input while the display mode is the invisible light display mode, a warning may be given by, for example, visually displaying a message “will you shut down in invisible light display mode?” by text. Furthermore, since a warning may be displayed with invisible light in the invisible display mode, and it may be impossible to visually perceive the warning without using a night vision device such as NVG, the warning may be given by outputting an audio.

In step S611, the CPU 110 changes the display mode from the visible light display mode to the invisible light display mode in accordance with the operation signal to change the display mode in step S604.

In step S612, the CPU 110 turns on the invisible light source 197 in the invisible light display mode, and determines whether an invisible light video signal is input from the invisible image input unit 192. If an invisible image is input, the process advances to step S613; otherwise, the process returns to step S602 to repeat the processes in steps S602 to S612.

In step S613, the CPU 110 performs projection control to display the invisible light video signal input in step S612, thereby performing projection display of the invisible image.

After that, in step S609, the CPU 110 determines whether a power-off operation signal is input by a user operation via the operation unit 113 or the remote controller while the invisible image is displayed in step S613, and performs subsequent processing in accordance with a determination result.

As described above, according to this embodiment, since the mode management unit 194 changes the display mode to the visible light display mode and stores it immediately before the projector main body is shut down, projection always starts in the visible light display mode at the time of the next activation. With this configuration, even if the projector is shut down in the invisible light display mode, the projector is never activated in the invisible light display mode at the time of the next activation. It is thus possible to prevent the inconvenience of the user not being able to see anything on the screen since he/she has no night vision device such as NVG. That is, the user can operate the projector main body with the naked eyes without using a night vision device such as NVG at the time of activation after power-on. Note that this embodiment is also applicable to a projector capable of projecting visible and invisible images at the same time. In the display state in which the user can visually perceive nothing with naked eyes, the above operation is performed by considering this state as the invisible light display mode, thereby obtaining the same effect.

### Second Embodiment

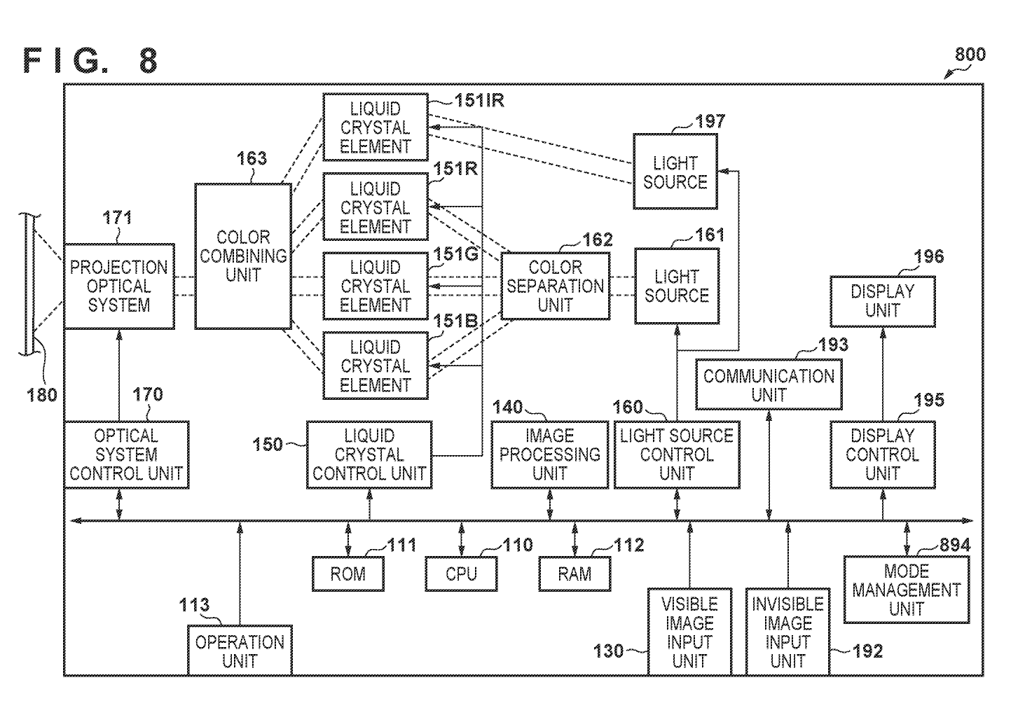

The operation of a liquid crystal projector according to this embodiment after power-on will be described next with reference to FIGS. 8 to 10.

Note that the configuration and basic operation of a liquid crystal projector 800 according to this embodiment are the same as in FIG. 1, and the internal configuration of a mode management unit 894 is different, as will be described later. The same components are denoted by the same reference numerals and a description thereof will be omitted. The same applies to a case in which the DLP projector 500 is applied instead of the liquid crystal projector 800.

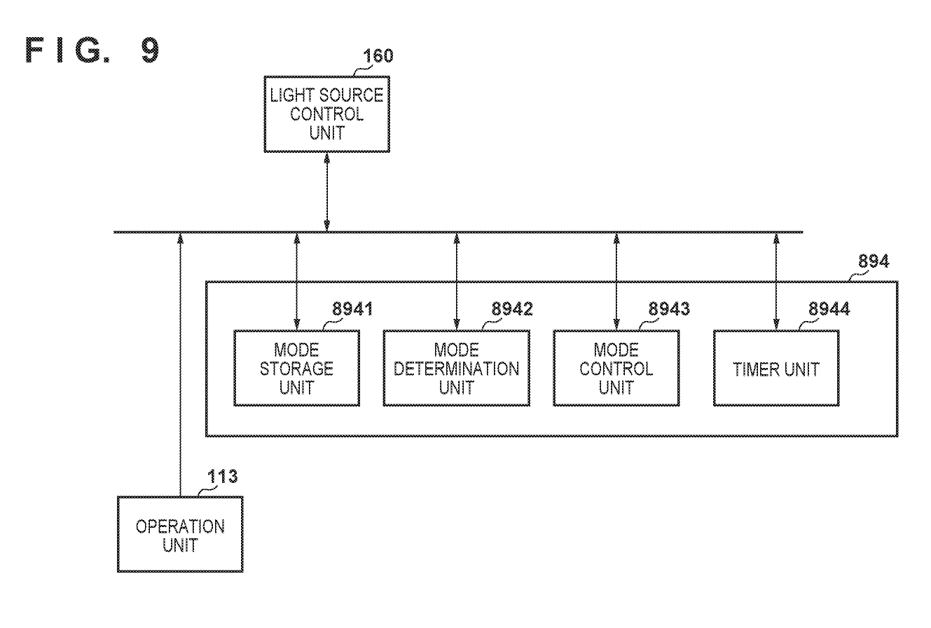

The configuration and function of the mode management unit 894 will be described with reference to FIG. 9.

The mode management unit 894 includes a timer unit 8944 in addition to a mode storage unit 8941, a mode determination unit 8942, and a mode control unit 8943.

The mode management unit 894 causes the mode storage unit 8941, the mode determination unit 8942, the mode control unit 8943, and the timer unit 8944 to perform activation processing at the time of power-on and display mode setting processing in accordance with the display mode.

The mode storage unit 8941 stores the display mode set at the time of the previous shutdown. The mode storage unit 8941 is a nonvolatile internal memory or an external storage medium such as an HDD or memory card but may be implemented by a volatile memory as long as it is possible to hold stored contents by keeping the memory unit ON even after the projector main body is powered off.

The mode determination unit 8942 determines the display mode at the time of activation of the projector main body. If the mode determination unit 8942 determines that the display mode is the invisible light display mode, the mode control unit 8943 changes the display mode from the invisible light display mode to the visible light display mode. If the mode determination unit 8942 determines that the display mode is the invisible light display mode, the timer unit 8944 notifies the mode control unit 8943 of an elapsed time after the mode control unit 8943 changes the display mode to the visible light display mode. The mode control unit 8943 controls to return the setting from the visible light display mode to the invisible light display mode when the time measured by the timer unit 8944 exceeds a predetermined time.

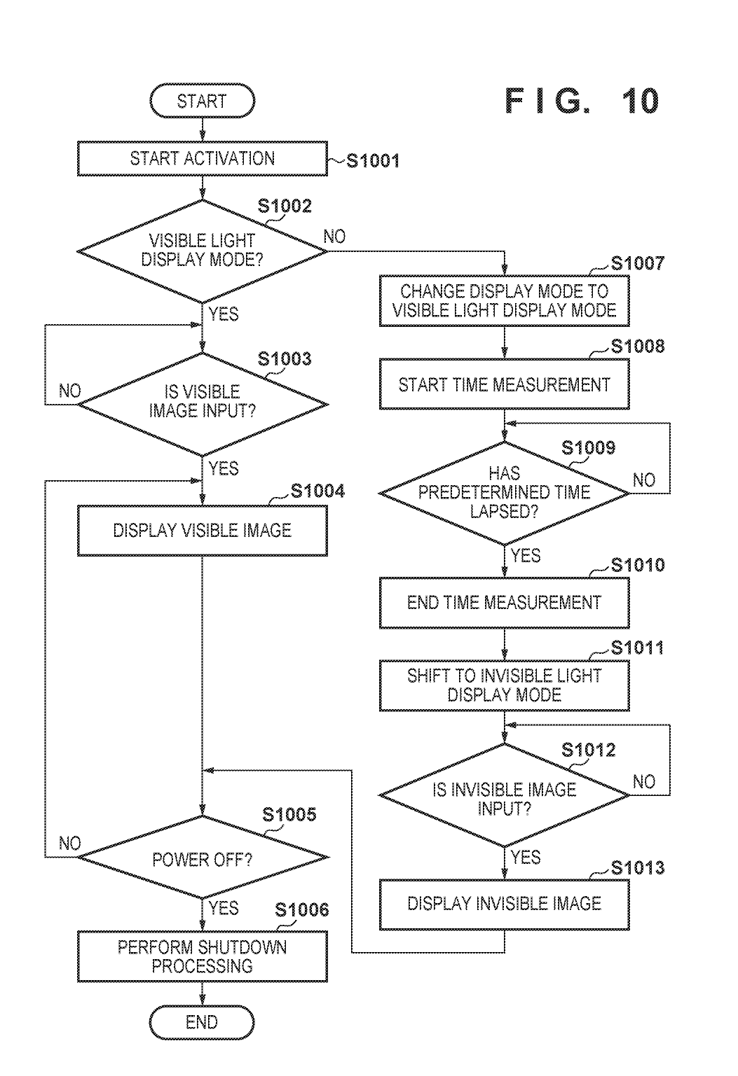

The operation of the liquid crystal projector 800 according to this embodiment after power-on will be described next with reference to FIG. 10.

It is assumed that the liquid crystal projector 800 according to this embodiment is activated in the display mode set at the time of the previous shutdown and stored in the mode storage unit 8941 of the mode management unit 894. If, however, the display mode at the time of activation is the invisible light display mode, control is performed to activate the liquid crystal projector by changing the setting to the visible light display mode.

FIG. 10 illustrates the operation of the liquid crystal projector 800 according to this embodiment after power-on. Note that processes in steps S1001, S1003, S1004, S1005, S1006, S1012, and S1013 of FIG. 10 are the same as those in steps S601, S605, S606, S607, S610, S612, and S613 of FIG. 6 and the difference will be mainly described below.

In step S1001, a CPU 110 starts the activation processing of the projector main body in accordance with a power-on operation signal.

In step S1002, the CPU 110 outputs, to the mode management unit 894, a control signal to determine the display mode, and the mode management unit 894 determines the display mode set at the time of the previous shutdown. If the determination result indicates the visible light display mode, the process advances to step S1003. If the determination result indicates the invisible light display mode, the process advances to step S1007.

In steps S1003 to S1006, the processes in step S605 and subsequent steps of FIG. 6 are performed. On the other hand, in steps S1007 to S1011, even in the state in which the invisible light display mode is set, display is performed in the visible light display mode only for a predetermined time after power-on. Thus, the user can operate the projector main body with naked eyes without using a night vision device such as NVG at the time of activation after power-on.

In step S1007, the CPU 110 outputs, to the mode management unit 894, a control signal to change the display mode to the visible light display mode, and the mode management unit 894 causes the mode control unit 8943 to set the display mode to the visible light display mode.

In step S1008, the CPU 110 outputs, to the mode management unit 894, a control signal to start time measurement, and the mode management unit 894 causes the timer unit 8944 to start time measurement.

In step S1009, the CPU 110 stands by until the time measured by the timer unit 8944 of the mode management unit 894 exceeds a predetermined time. If the measured time exceeds the predetermined time, the process advances to step S1010.

In step S1010, the CPU 110 outputs a control signal to the mode management unit 894 to end the time measurement. The mode management unit 894 stops the time measurement by the timer unit 8944. Note that the time measured by the timer unit 8944 may be stored in the ROM 111 in advance, or arbitrarily settable by the user via the operation unit 113 or the remote controller.

In step S1011, the CPU 110 outputs a control signal to the mode management unit 894 to change, to the invisible light display mode, the display mode set to the visible light display mode in step S1007. The mode management unit 894 causes the mode control unit 8943 to change the display mode to the invisible light display mode.

After that, similarly to steps S612 and S613 of FIG. 6, in steps S1012 and S1013, projection display of an invisible image is performed. Note that unlike step S612, in step S1012, the CPU 110 stands by until an invisible light video signal is input. However, it may be configured to always allow an interrupt of processing with high priority such as shutdown.

Note that if a predetermined time elapses without performing any operation for the projector after the display mode at the time of activation is changed to the visible light display mode in step S1008, a warning may be given by, for example, displaying a message “no operation has been performed for predetermined time” by text or outputting an audio.

As described above, according to this embodiment, control is performed to set the display mode to the visible light display mode for a predetermined time after power-on, and then return the display mode to the invisible light display mode. Therefore, since the display mode is always set to the visible light display mode at the time of activation after power-on, it is possible to prevent the inconvenience of the user not being able to see anything on the screen because he/she has no night vision device such as NVG. That is, the user can operate the projector main body with naked eyes without using a night vision device such as NVG for the predetermined time after power-on. Note that this embodiment is applicable even in the third display mode capable of projecting visible and invisible images at the same time. In the display state in which the user can visually perceive nothing with naked eyes, the above operation is performed by considering this state as the invisible light display mode, thereby obtaining the same effect.

### Third Embodiment

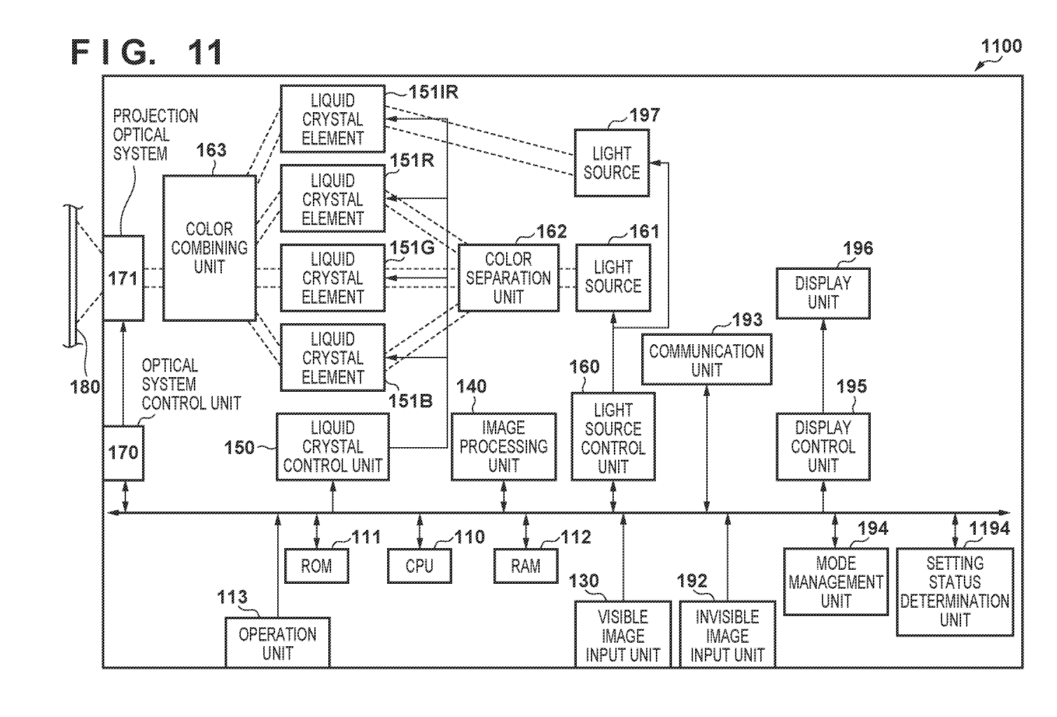

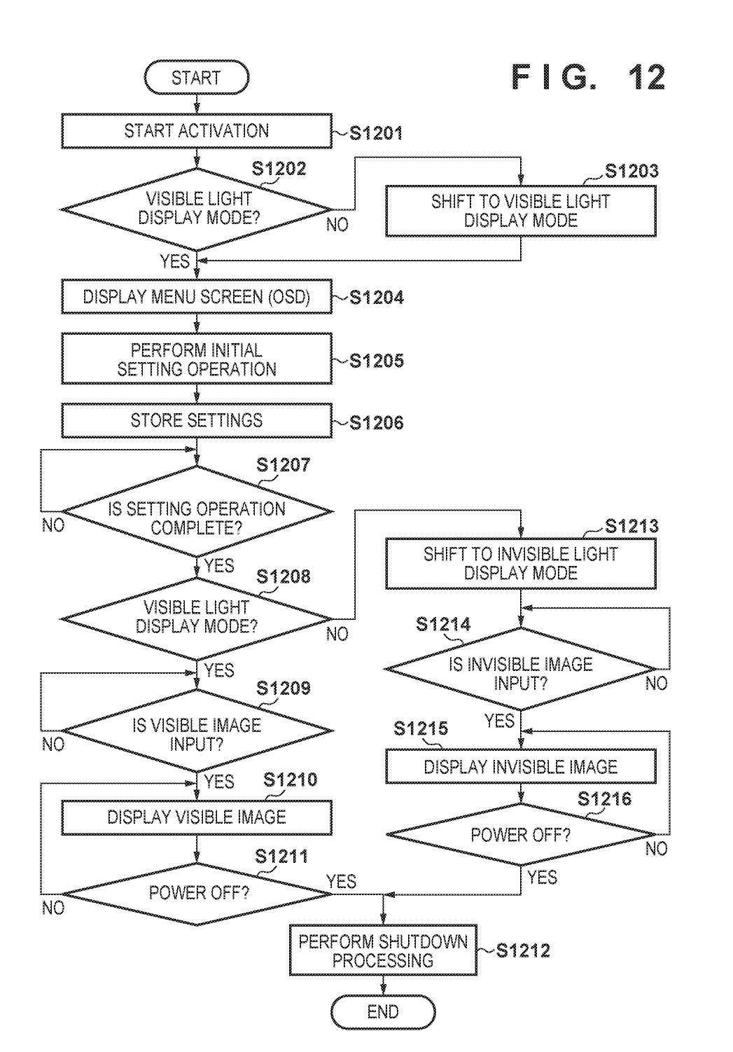

The operation of a liquid crystal projector 1100 according to this embodiment after power-on will be described next with reference to FIGS. 11 and 12.

Note that the configuration and basic operation of the liquid crystal projector 1100 according to this embodiment are the same as in FIG. 1, and a setting status determination unit 1194 (to be described later) is added. The same components are denoted by the same reference numerals and a description thereof will be omitted. The same applies to a case in which the DLP projector 500 is applied instead of the liquid crystal projector 1100.

A mode management unit 194 causes a mode storage unit 1941, a mode determination unit 1942, and a mode control unit 1943 to perform activation processing at the time of power-on and display mode setting processing in accordance with the display mode.

The mode storage unit 1941 stores a display mode set at the time of the previous shutdown. The mode determination unit 1942 determines a display mode at the time of activation of the projector main body. If the mode determination unit 1942 determines that the display mode is the invisible light display mode, the mode control unit 1943 changes the display mode from the invisible light display mode to the visible light display mode.

The function of the setting status determination unit 1194 will be described with reference to FIG. 11.

The setting status determination unit 1194 has a function capable of determining the status of a setting operation for the projector main body in the visible light display mode at the time of activation and detecting that the operation starts, is in progress, or ends, or a function of estimating the end of the operation by providing a timer unit for performing time measurement. A CPU 110 displays a menu screen (OSD) that accepts a user operation for making various settings in the projector main body in the visible light display mode after activation. The setting status determination unit 1194 notifies the CPU 110 of the status of the setting operation for the projector main body. The setting status determination unit 1194 is a sequencer such as an ASIC formed by a dedicated logic circuit. Note that the setting status determination unit 1194 need not be a dedicated ASIC. For example, the CPU 110 may execute determination processing using a program stored in a ROM 111.

Items set after activation of the projector include, for example, focus adjustment and size adjustment of a projected image as initial settings after activation. In this case, if an operation signal to drive a projection optical system 171 is input by a user operation via an operation unit 113 or a remote controller, the CPU 110 outputs, to an optical system control unit 170, a control signal to change the focus of the projected image or change the enlargement ratio of the optical system. The optical system control unit 170 controls the actuator of the projection optical system 171 to make settings concerning the projection optical system 171. In addition, initial settings along with projection such as settings of a geometric correction unit 405 of an image processing unit 140 are made. Note that settable items are not limited to them, and are applicable to necessary settings along with projection, an operation concerning display, and the like. The initial settings include, for example, the items described in step S603 of FIG. 6.

If the display mode at the time of activation (the display mode set at the time of the previous shutdown) is the invisible light display mode, the liquid crystal projector 1100 according to this embodiment visually displays a menu screen (OSD) after changing the display mode to the visible light display mode. This allows the user to perform various setting operations concerning the projector while viewing the visually displayed menu screen (OSD). Furthermore, upon completion of the setting operation, display of the menu screen (OSD) stops and projection display starts in the display mode set at the time of the previous shutdown.

The operation of the liquid crystal projector 1100 according to this embodiment after power-on will be described next with reference to FIG. 12.

FIG. 12 shows the operation of the liquid crystal projector 1100 according to this embodiment after power-on. Note that processes in steps S1201, S1202 (S1208), S1209, S1210, S1211, S1212, S1213, S1214, S1215, and S1216 of FIG. 12 are the same as those in steps S1001 and S1002 of FIG. 10 and steps S604, S605, S606, S607, S610, S612, S613, and S607 of FIG. 6 and the difference will be mainly described below.

If it is determined in step S1202 that the display mode at the time of activation is the visible light display mode, the process advances to step S1204. If the display mode is the invisible light display mode, the process advances to step S1203.

In step S1203, the CPU 110 changes the display mode to the visible light display mode, and then advances to step S1204.

In step S1204, the CPU 110 displays the menu screen (OSD) in the visible light display mode by controlling the respective operation blocks. This allows the user to perform various setting operations concerning the projector by operating the operation unit 113 or the remote controller while viewing the menu screen (OSD).

In step S1205, if the user performs a setting operation via the menu screen (OSD), the CPU 110 performs an initial setting operation in accordance with the user operation.

In step S1206, the CPU 110 stores, in the ROM 111 or a RAM 112, contents set in step S1205. Alternatively, the CPU 110 may store the contents in a nonvolatile internal memory, an external storage medium such as an HDD or memory card, or a volatile memory as long as it is possible to hold stored contents by keeping the memory unit ON even after the projector is powered off.

In step S1207, the CPU 110 stands by until the setting status determination unit 1194 determines that the setting operation in step S1205 and the storage operation in step S1206 are complete. If these operations are complete, the CPU 110 advances to step S1208.

Similarly to step S1002 of FIG. 10, in step S1208, the display mode set at the time of the previous shutdown is determined. After that, processing (steps S1209 to S1211) corresponding to the visible light display mode or processing (steps S1214 to S1216) corresponding to the invisible light display mode is performed until a power-off operation signal is input.

If it is determined in step S1208 that the invisible light display mode is set, after the completion of the setting operation in steps S1204 to S1207, the display mode is returned to the invisible light display mode which has been set before changing the display mode in step S1203, thereby allowing projection display of an invisible image (steps S1213 to S1215). The user can visually perceive the projected image using a night vision device such as NVG.

Note that in this embodiment, if the display mode at the time of activation (the display mode set at the time of the previous shutdown) is the invisible light display mode, the menu screen (OSD) is displayed after changing the display mode to the visible light display mode. However, only the menu screen (OSD) may be visually displayed in the invisible light display mode without changing the display mode. This allows the user to perform various setting operations concerning the projector while viewing the menu screen (OSD) even in the invisible light display mode. Furthermore, when switching the display mode from the visible light display mode to the invisible light display mode, the user may be notified of it by visually displaying a message “display mode will be switched in some seconds” by text or outputting an audio.

As described above, according to this embodiment, if the display mode is changed to the visible light display mode after power-on of the projector main body, and the initial setting operation is completed, projection display in the preset display mode starts. Therefore, since the display mode is always set to the visible light display mode at the time of activation after power-on, it is possible to prevent the inconvenience of the user not being able to see anything on the screen since he/she has no night vision device such as NVG. That is, after power-on, the user can operate the projector main body with naked eyes without using a night vision device such as NVG. Note that this embodiment is applicable even in the third display mode capable of projecting visible and invisible images at the same time. In the display state in which the user can visually perceive nothing with naked eyes, the above operation is performed by considering this state as the invisible light display mode, thereby obtaining the same effect. In this case, the following control may be performed not to suddenly display a bright visible image to the user wearing a night vision device such as NVG. (1) Control is performed to make the ratio (proportion) of the visible image higher than that of the invisible image. (2) Control is performed to make the luminance of the visible image lower than that in the normal visible light display mode. (3) The luminance of the visible image is controlled to gradually become higher from a state in which the luminance is lower than that in the normal visible light display mode. (4) If the ratio (proportion) of the visible image is lower than a predetermined one, control is performed to increase the ratio (proportion) of the visible image.

Note that a configuration may be adopted in which the user can set whether to execute control of each embodiment described above at the time of activation of the projector main body.

In the above-described embodiments, also note that the visible light display mode is not limited to the display mode of using only visible light, and may additionally include invisible light. For example, the visible light display mode may be set when the ratio (proportion) of visible light is sufficiently higher than that of invisible light or when the ratio (proportion) of visible light is higher than a predetermined threshold.

Furthermore, the invisible light display mode is not limited to the display mode of using only invisible light, and may additionally include visible light. For example, the invisible light display mode may include a projection state in which the ratio (proportion) of invisible light is sufficiently higher than that of visible light and visual perception by the naked eyes is thus difficult, and a case in which the ratio (proportion) of invisible light is higher than a predetermined threshold.

If the state of the apparatus at the time of shutdown is the invisible light display mode or the projection state in which the amount of visible light is small and visual perception by the naked eyes is difficult, control may be performed to set the visible light display mode at the start of next activation or set, by increasing the ratio (proportion) of visible light, a projection state in which visual perception by the naked eyes is easy.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-196729, filed Oct. 4, 2016, which is hereby incorporated by reference herein in its entirety.

What is claimed is:

1. A projection apparatus comprising:
a projection control unit configured to control a projection unit capable of projecting an image on a projection surface with at least one of visible light and invisible light; and
a control unit configured to control a projection state at a start of activation based on a projection state at the time of shutdown of the apparatus,
wherein if the state at the time of shutdown of the apparatus is a state in which the visible light is projected, the control unit controls to set the state in which the visible light is projected at a start of next activation, and
if the state at the time of shutdown of the apparatus is a state in which only the invisible light is projected, the control unit controls to set a projection state including at least the visible light at the start of next activation.

2. The apparatus according to claim 1, wherein if the state at the time of shutdown of the apparatus is the state in which only the invisible light is projected, the control unit shuts down the apparatus after changing the state to the state in which the visible light is projected.

3. The apparatus according to claim 1, wherein if the state in which only the invisible light is projected is set at the start of activation, the control unit activates the apparatus by changing the state to the state in which the visible light is projected.

4. The apparatus according to claim 3, wherein the control unit further returns the state to the state in which only the invisible light is projected after a predetermined time elapses since projection of the visible light.

5. The apparatus according to claim 4, wherein the control unit displays one of a menu image and a guidance image with the visible light.

6. The apparatus according to claim 1, further comprising:
a setting unit configured to set one of a plurality of projection states including a first projection state in which the visible light is projected and a second projection state in which the invisible light is projected.

7. The apparatus according to claim 6, wherein
a third projection state in which a projection ratio between the visible light and the invisible light can be changed is included, and
if the state at the start of activation of the apparatus is the third projection state, when the ratio of the visible light is lower than a predetermined ratio, the control unit increases the ratio of the visible light.

8. The apparatus according to claim 1, wherein if the apparatus is shut down in the state in which only the invisible light is projected, the control unit gives a warning.

9. The apparatus according to claim 8, wherein the warning is given by an audio.

10. The apparatus according to claim 1, wherein the invisible light is infrared light.

11. A control method of a projection apparatus having a projection control unit configured to control a projection unit capable of projecting an image on a projection surface with at least one of visible light and invisible light, and a control unit configured to control a projection state at a start of activation based on a projection state at the time of shutdown of the apparatus, the method comprising:
controlling, if the state at the time of shutdown of the apparatus is a state in which the visible light is projected, to set the state in which the visible light is projected at a start of next activation, and
controlling, if the state at the time of shutdown of the apparatus is a state in which only the invisible light is projected, to set a projection state including at least the visible light at the start of next activation.

12. A computer-readable storage medium storing a program for causing a computer to execute a control method of a projection apparatus having a projection control unit configured to control a projection unit capable of projecting an image on a projection surface with at least one of visible light and invisible light, and a control unit configured to control a projection state at a start of activation based on a projection state at the time of shutdown of the apparatus, the method comprising:
controlling, if the state at the time of shutdown of the apparatus is a state in which the visible light is projected, to set the state in which the visible light is projected at a start of next activation, and
controlling, if the state at the time of shutdown of the apparatus is a state in which only the invisible light is projected, to set a projection state including at least the visible light at the start of next activation.

13. The medium according to claim 12, wherein the method includes shutting down, if the state at the time of shutdown of the apparatus is the state in which only the invisible light is projected, the apparatus after changing the state to the state in which the visible light is projected.

14. The medium according to claim 12, wherein the method includes activating, if the state in which only the invisible light is projected is set at the start of activation, the apparatus by changing the state to the state in which the visible light is projected.

15. The medium according to claim 14, wherein the method includes returning the state to the state in which only the invisible light is projected after a predetermined time elapses since projection of the visible light.

16. The medium according to claim 15, wherein the method includes displaying one of a menu image and a guidance image with the visible light.

17. The medium according to claim 12, wherein the apparatus further comprises a setting unit configured to set one of a plurality of projection states including a first projection state in which the visible light is projected and a second projection state in which the invisible light is projected.

18. The medium according to claim 17, wherein
a third projection state in which a projection ratio between the visible light and the invisible light can be changed is included, and
the method includes increasing the ratio of the visible light if the state at the start of activation of the apparatus is the third projection state and the ratio of the visible light is lower than a predetermined ratio.

19. The medium according to claim 12, wherein the method includes giving a warning if the apparatus is shut down in the state in which only the invisible light is projected.

20. The medium according to claim 19, wherein the warning is given by an audio.

21. The medium according to claim 12, wherein the invisible light is infrared light.
